(19) United States
(12) Patent Application Publication
(10) Pub. No.: US 2017/0069051 A1
(43) Pub. Date: Mar. 9, 2017

(54) ATMS Bank Emergency Response System

(71) Applicants: Felix Houston Petitt, SR., Key West, FL (US); Felix Houston Petitt, JR., Key West, FL (US); Emily Jem Petitt, Key West, FL (US)

(72) Inventors: Felix Houston Petitt, SR., Key West, FL (US); Felix Houston Petitt, JR., Key West, FL (US); Emily Jem Petitt, Key West, FL (US)

(21) Appl. No.: 14/847,268

(22) Filed: Sep. 8, 2015

(51) Int. Cl. G06Q 50/26; G06Q 20/10; G06Q 20/40

(52) U.S. Cl. CPC G06Q 50/265; G06Q 20/4012; G06Q 20/1085

(57) ABSTRACT

The ATMS network is a security platform built on ATM technology implementing a new ATMS Terminal booth enclosure, adaptable sensor array technology, plaza surveillance technologies that provide live audio/video streaming 24/7 to the ATMS BERS cloud service and new security protocols. The banking customer now has a means of protection with the new BERSPA and BERSDA PIN numbers added to their EMV cards that implement immediate assistance when used at an ATMS Terminal. This technology provides endangerment support to banking customers. Whether the banking customer has been accosted or the whole family is under siege the only support available to them is due diligence and ATMS.

### TECHNICAL FIELD

Certain embodiments of the present disclosure generally relate to ATM usage and network connection to the Internet for access to secure cloud services and, more particularly to the security implementation of the ATM and surrounding plaza to safeguard the customer and act as a calming service to the community.

### BACKGROUND

The current ATM comes in various designs; open enclosures, standing units, and wall walk-up fixtures. These devices are designed to secure the money that is contained within and perform basic banking functions over a network for the bank and customer.

Criminal activity occurring around these various kiosks has fed into a huge ATM crime industry. Threats of violence at these locations force patrons to access their accounts and surrender their financial savings to criminals. Cameras around the ATM are usually low resolution fixed cameras that rarely provide enough data to apprehend a criminal after and, even more rarely, during an assault. The ATM has become a quick means to obtain money by criminals without fear of reprisal or capture as ATM crimes offer fast access to money.

The resulting behavior of customers using ATMs has created a demographic awareness within the community that has tapered off access locations and time periods during the day when access is deemed safe. This creates a loss of business opportunities for the banking institutions and a loss of convenience to the consumer.

The ATM crime industry has created many ways for criminals to harass and harm ATM patrons. Extortion, kidnapping and murder have desensitized communities to this criminal behavior. Present day threats have become more insidious in nature and action where homes are raided by criminals who force members to withdraw the family's life savings only to turn around and rape, torture and finally murder elderly, children and whole families. Communities that have had this happen are shocked that such criminals not only exist, but get away with their crimes and lurk for the next unsuspecting family. In such scenarios there seems tote no possibility of hope for the family as they must rely on the kindness and honor of criminals.

The banking institutions have no customer service for crime in progress. The banking customer is at the mercy of their attacker and the crime becomes a personal assault that further overwhelms the customer as they have no support structure in place to ask for help. This disclosure addresses this problem and provides a reasonable solution benefiting the banking institution, the customers and their families.

### SUMMARY OF THE DISCLOSURE

Certain embodiments provide a method for the banking ATM customer to request assistance from the ATMS Bank Emergency Response Service asking for police action whereby the police are notified immediately to protect the customer and financial property.

Certain embodiments provide a method for the banking ATM customer to request assistance from the ATMS Bank Emergency Response Service asking for a discreet police action to immediately initiate protection for self, family and financial property.

Certain embodiments provide a method for ATM banking customers to access the new ATMS Terminal, which will provide handicap and accommodate a complete range of sizes for customers with adaptable technology incorporated within the ATM Terminal enclosure design.

Certain embodiments provide a method for the ATMS Bank Emergency Response Service, an internet-based cloud entity, personnel to monitor the ATM and associated plaza to collect detailed audio/video data for law enforcement personnel to understand the incident outlay prior to arrival at the event or incident location. This provides law enforcement or first responders a number of suspects, victims and weapons to plan for. Such information gleaned prior to arrival will affect the number of officers on scene and first responders required to safeguard the victims) and make the site safe for the community.

Certain embodiments provide a method for the ATMS Bank Emergency Response Service personnel to contact and stay in communication with law enforcement officers and first responders providing them with one-time access codes to the event or incident cloud folder to view the streaming data from the ATMS Terminal and Plaza location.

Certain embodiments provide a method for the ATMS Bank Emergency Response Service personnel to manipulate services to the ATM when a customer needs more time for the law officials to arrive. Manipulation can include additional counter measures.

Certain embodiments provide a method for the ATMS Bank Emergency Response Service personnel to initiate an incident folder and monitor the ATMS Terminal when someone inserts an EMV card and 4-number PIN repeatedly without providing biometric authentication. In such events the BERS personnel can challenge the person by requesting identification that will lead to a biometric scan or the security door will close for Police Action.

Certain embodiments provide a method for the ATMS Bank Emergency Response Services personnel to assist customers and non-customers during life threatening situations within and around the ATMS Terminal and Plaza. Such embodiments allow the protection of the community and increased banking opportunities to the banking institutions and customers as the demographic location of the ATMS Terminal and Plaza become known as a safe zone to the community and activities within this protected area increase as threats diminish.

Certain embodiments provide a method for ATMS to monitor the ATMS Terminal and Plaza throughout the day, 24 hours a day and 7 days a week, depositing live audio/video to daily cloud folders to be used upon request by policing authorities conducting investigations.

Certain embodiments provide a method for ATMS to monitor the ATMS Terminal and Plaza throughout the night with BERS personnel viewing the live audio/video data between the hours of 8 pm to 6 am to ensure safety of patrons and report criminal activities around the plaza.

Certain embodiments provide a method for ATMS to monitor the ATMS Terminal and Plaza during inclement weather and storms. During such events all data is streamed to an event cloud folder. To safeguard the electronics within the ATMS Terminal the security door is closed and sealed during severe weather and just closed during inclement weather. Banking will be offline during sever weather. The security door will open and close to allow entry to banking customers during inclement weather providing a comfortable private space to use the ATM.

Certain embodiments provide a method for ATMS to monitor the ATMS Terminal and Plaza during power outages. The backup electrical systems will keep the ATMS Terminal and Plaza security powered during power outages. Air-conditioning will be on a different circuit and will not be powered during such events. Banking will be suspended to protect customers.

Certain embodiments provide a method for ATMS to use external ATMS Terminal audio/video within the protected enclosed sensor array housing to allow BERS personnel to adjust and manipulate the zoom functions of the cameras, the angle of the cameras, and the audio alignment of the microphones for accurate data streaming to the cloud folders.

Certain embodiments provide a method for ATMS to use internal ATMS Terminal audio/video/and tactile technologies within the protected enclosed sensor array housing, flooring and video service screen to provide the banking customer an automated experience with BERS customer support providing external security assistance when needed.

Certain embodiments provide a method for ATMS to use perimeter audio/video technologies mounted on light columns spaced evenly or logistically around the ATMS Terminal Plaza enabling BERS personnel to manipulate the audio/video technologies to various angles, zoom capabilities, infrared and FLIRS monitoring during power outages providing detailed data to stream to the cloud folder for review by authorities and responders. Speakers built in to the columns will allow interaction between BERS personnel and people in need of assistance.

### BRIEF DESCRIPTIONS OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting in scope, for the disclosure may admit to other equally effective embodiments.

FIG. 1 illustrates the three Personal Information Numbers that will be associated to the customer's account and the ATMS BERS cloud service. These PINs are illustrated as follows: FIG. 1A is the standard 4-number PIN that enables normal access to the customer bank accounts; FIG. 1B illustrates the ATMS Bank Emergency Response Services; FIG. 1C is the 4-number PIN that initiates the Police Action, BERSPA, request; FIG. 1D is the 4-number PIN that initiates the Discreet Action, BERSDA, request.

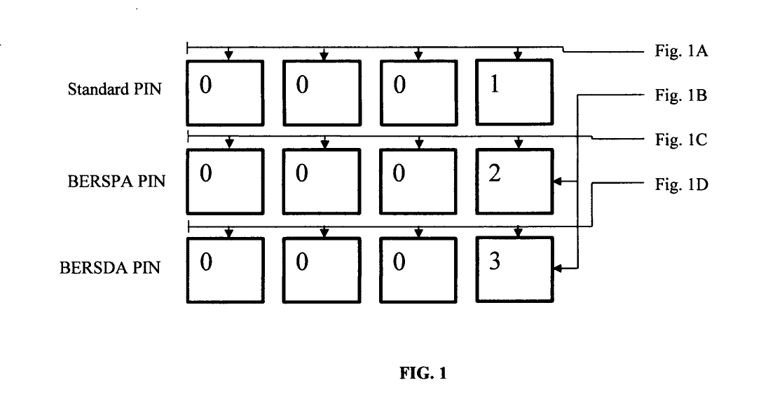

FIG. 2 illustrates the ATMS Terminal enclosure design; which will adapt to commercial advertising demands and varied genre designs. The basic height and width are shown with an illustration of the adaptive flooring sensor within the booth. The basic components of this design include: FIG. 2A the exterior housing that will include the ATMS logo, bulletproof layer—if applicable to the demographic location, an advertisement film for streaming Wi-Fi advertisements on the exterior—if applicable to the demographic location, an audio/video sensor array that will monitor the outside of the booth structure during normal and offline periods for daily data streaming to the daily drop box and during incidents where data is streamed to event and incident drop boxes; FIG. 2B illustrates the adaptive touch screen technology and placement of the input and output devices to make this service convenient to all sizes of customers and those that must use wheelchairs to access the booth comfortably; FIG. 2C illustrates the internal sensor array incorporating audio/video technology for data collection, speakers systems and screen on screen communication with BERS personnel and the customer, and the adaptable floor sensor that provides spatial input to the sensor array to give such information as number of people in the booth, weight and where they should place themselves during an emergency—pets are also considered children and will have their footprints displayed as well; FIG. 2D illustrates the open security door with interior adaptive flooring; FIG. 2E illustrates the closed security door and the ground level to the ATMS Terminal for perspective and scale.

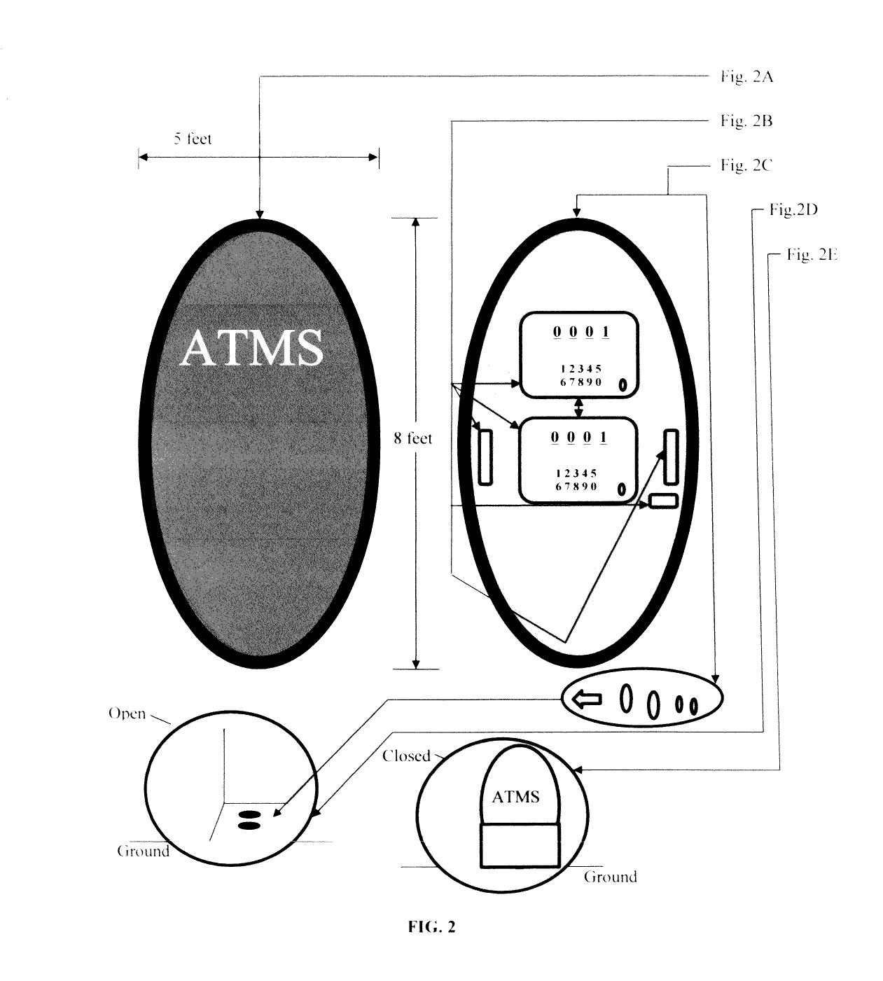

FIG. 3 illustrates the ATMS Bank Emergency Response Service and corresponding BERSPA and BERSDA initiation by the banking customer to access the network cloud service from the ATMS Terminal and Plaza location. The illustration depicts the various components of ATMS as follows: FIG. 3A illustrates the BERS cloud service accessed by the ATMS; FIG. 3B illustrates the live personnel working with the customer during a BERSPA or BERSDA incident; FIG. 3C illustrates the ATMS Terminal used to initiate the BERS incidents and immediate connection with the BERS Cloud Service.

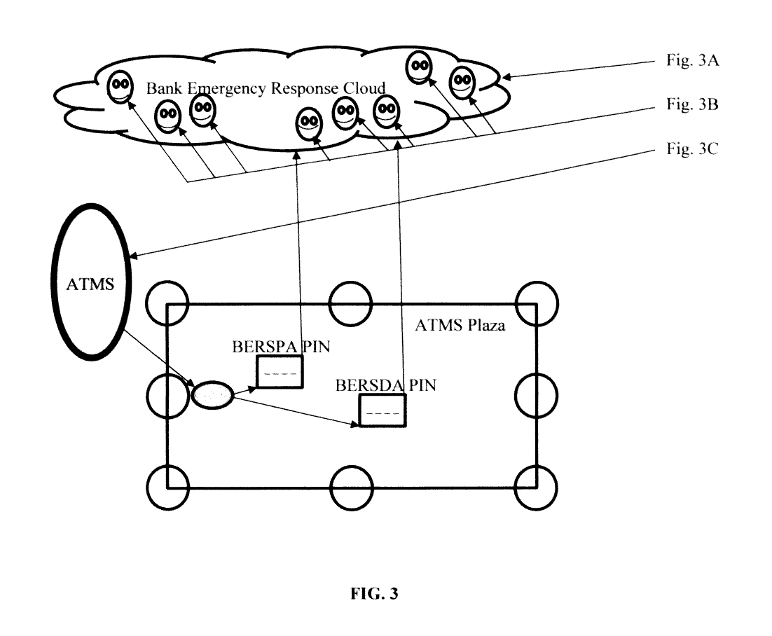

FIG. 4 illustrates the ATMS Terminal and Plaza networked audio/video data collection systems interacting with the BERS cloud service during daily operations, events, and BERSPA and BERSDA incidents. This illustrates the live feed data collecting into the drop boxes for access by the authorities. This illustration reveals the components of the security network activity: FIG. 4A illustrates the general arrangement of the ATMS Plaza security camera outlays and their connectivity to the ATMS Terminal and BERS Cloud Services; FIG. 4B illustrates the ATMS Wi-Fi connectivity streaming the Plaza and Terminal data to the BERS cloud services; FIG. 4C illustrates the perimeter audio/video network linking to the ATMS Wi-Fi for streaming live data to the BERS Cloud; FIG. 4D illustrates the live data streaming to the Daily data folder; FIG. 4E illustrates the live data streaming to the Event data folder covering inclement weather, power outages, service interruptions and storms.

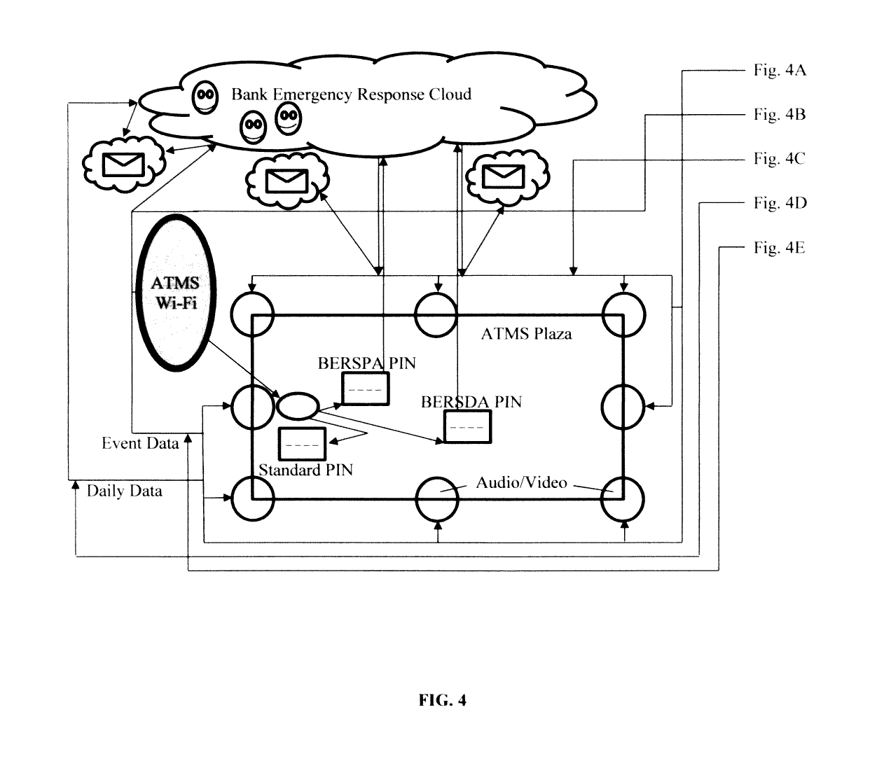

FIG. 5 illustrates the ATMS BERS cloud service interaction during a Police Action initiated at the ATMS Terminal and Plaza by the banking customer. This illustration depicts: FIG. 5A the ATMS BERS drop box for the Police Action Incident; FIG. 5B the ATMS Plaza and Terminal audio/video network streaming live data to the BERS Cloud Service for personnel to acquire evidence; FIG. 5C the marked police officer's vehicle arriving at the scene to offer assistance to the banking customer.

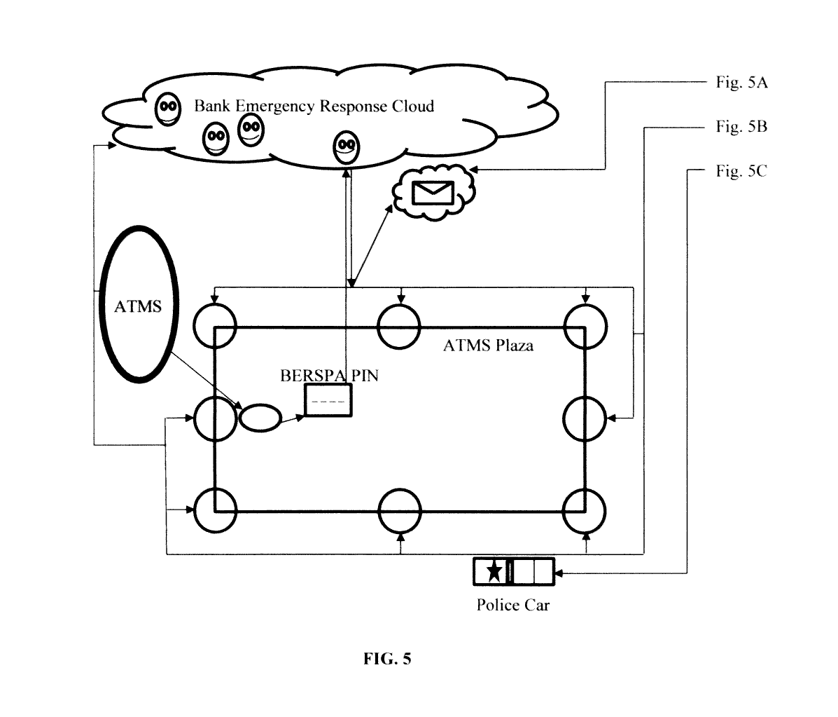

FIG. 6 illustrates the ATMS BERS cloud service interaction during a Discreet Action initiated at the ATMS Terminal and Plaza by the banking customer. This illustration depicts: FIG. 6A the ATMS BERS Drop Box for the Discreet Action Incident; FIG. 6B the ATMS Plaza and Terminal audio/video network streaming live data to the BERS Cloud Service for personnel to acquire evidence; FIG. 6C the unmarked police officer vehicle arriving at the scene.

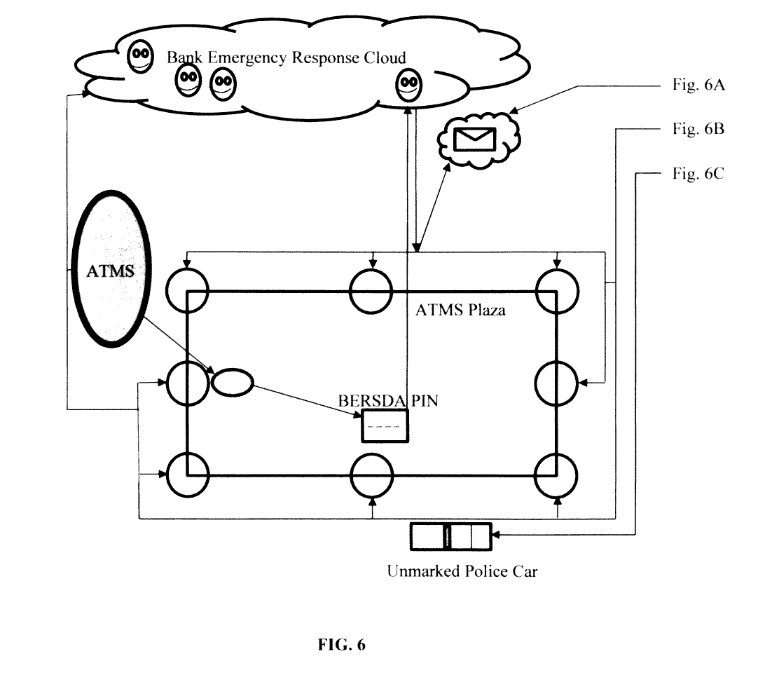

### DETAILED DESCRIPTION

Embodiments of the present disclosure may allow the ATMS to interface with the banking institutions ATM technology allowing banking customers to access their accounts and allow ATMS BERS personnel control of the ATMS housing surrounding the ATM technology to control access by the customer, maintenance personnel and suspects. These embodiments will access the ATM network connections whereby interface with the BERS Cloud where personnel will provide security services to the banking customer are established.

As a result, the techniques provided herein may help reduce crime in and around ATM Terminals and plazas. By providing better evidentiary data to law enforcement personnel more apprehensions can take place, thus removing the criminal element from the community and summarily encouraging a safer and more active banking customer to freely use the ATM services without fear of criminal mischief or threat of life and endangerment to family

### An Exemplary Banking Security Platform for ATM Usage

The methods and apparatus of this disclosure may be utilized in any banking location that can support the ATMS Terminal design and incorporated plaza security elements.

The ATMS Terminal incorporates an external sensor array that records, through the manner of streaming, live audio and video to the BERS cloud services to daily, event, incident and maintenance folders. The booth design accommodates handicapped customers and various sized customers. The service screen inside incorporates a large touch screen allowing a customer to tap and adjust the screen location and orientation to the customer. The flooring is a lit sensor panel that monitors the position of the customer and accompanying adults, children and pets. This assists the internal sensor array to orient the service screen automatically. The cash, check, and withdrawal slots are set at a neutral location at the sides of the booth. An emergency door works in conjunction with the floor sensors to provide a protective feature for the customer. The outside of the ATMS Terminal uses a bulletproof layer for added protection.

ATMS monitors fraudulent ATM activity that can be automatically triggered by user input. The BERS Cloud Service initiates automatically when an EMV card is inserted and the PIN is repeatedly inputted. When this happens, the ATMS BERS Cloud Service initiates an incident folder and all live audio and video are streamed to the folder. The card is placed in suspension and will not eject. The customer will understand that after the PIN is initiated a biometric input is required. Someone finding a purse or wallet that also contains the PIN to the banking customer's accounts will find accessing the accounts impossible. There will be no error messages or a biometric symbol appearing on the screen as the system will wait for the proper response. After the PIN is inputted the system will wait for the biometric and clear the PIN input after ten seconds. When the suspect attempts to eject the card a BERS Cloud Attendant will ask “Can we help you?” which will either lead to an embarrassed customer or a suspect fleeing the scene of a crime. The benefit is that the police will have clear evidence that can be used for an apprehension through the live data captured at the ATMS Terminal and Plaza

The ATMS Police Action PIN, which is created by the customer, initiates a 911 call from the BERS Cloud Service. During, such a scenario an assault at or around the ATMS Terminal and Plaza location has developed into a situation where a banking customer is being forced to withdraw savings from personal or corporate accounts from the ATM. Witnesses may help, but that is not a guarantee. The customer enters the ATMS Terminal under duress and initiates the Police Action PIN for immediate help. The ATMS Terminal opens a new drop box folder immediately and streams all audio and video data to the folder. The 911 emergency services are called and the dispatch personnel at the police department are given the one-time access code to access the incident drop box. Multiple codes can be issued for an incident drop box, but no code can be used twice as this would cause a security concern with ATMS. During a Police Action, the flooring of the ATMS Terminal mimics the customer's footprints and the customer needs to move to the right for the doors to quickly close. This separates the banking customer from the criminal immediately while awaiting the authorities. If a banking customer has children or pets their impressions on the flooring will also be mimicked for safely closing the door. If a child is being held by the suspect, the BERS personnel will inform the suspect that they have police on the way and to release the child immediately. The police will have full identification of the suspect to inform first responders on site for immediate seizing of the child and the suspect. If the suspect shoots at the booth or attempts injury to the shielded banking customer it will be a fruitless action as the booth is covered with a bullet proof material.

The ATMS Discreet Action initiation occurs when a family member is at the ATMS Terminal to withdraw money because there is a waiting car in the parking lot or at the customer's residence waiting for the liquidation of personal and corporate accounts. In this frightening scenario a home robbery has occurred and the family is being detained against their will and will be brutalized, raped and finally murdered once the family member returns. Rarely does a family get out of this scenario unscathed. In this regard, the banking customer has little recourse, but to initiate the ATMS Discreet Action. This initiates all actions the Police Action utilizes, but will not close the ATMS Terminal door nor communicate with the banking customer. All actions are discreet and irritatingly calm except for the slight delay in transaction time while the BERS personnel scour the plaza looking for the suspects. The drop box may not have any suspects to record as they may be waiting for the banking customer to return home so they can conclude their business and flee. The Discreet Action has two functions: 1^{st} the ATMS initiates the drop box and the BERS personnel calls 911 for that ATMS Terminal location; 2^{nd} the discreet action provides the police with the banking customer's home address. This action sends an undercover unit to the plaza to watch and wait and units to the home to attempt to save the family. If the family is quickly protected, the undercover police at the ATMS location can engage the suspect, if any, and the BERS personnel can shut the ATMS Terminal door to safeguard the customer. If the crime does not end there the undercover police will follow the banking customer to locate the customer's family in attempt to safeguard their lives.

The ATMS Terminal will be wide enough for wheelchair access and have a large service touch screen that will allow the virtual service screen to drop dawn to the customers height for convenience. The input and output slots will be to the sides of the booth. A sliding door will slide shut during emergencies, inclement weather, and storms. During rainy or snowy days the booth will be air conditioned to provide cool air and heated air. The booth door will open to allow entry and close to provide comfort and privacy. During an emergency, the booth will not open until the police arrive and the banking customer is safe. The outer shell of the ATMS Terminal has a bullet proof layer to further protect the banking customer. The floor of the ATMS Terminal is part of the internal sensor array that surrounds the inner shell of the terminal. This array incorporates audio and video equipment as well as scanning sensors for height weight and the number of occupants in the booth. Adults, children and pets are recorded by height and position. During emergencies, the adaptive flooring positions the foot prints to where they should be located prior to the security door closing. The biometric scanner is always located on the lower right of the touch screen and is not advertised as a security feature of ATMS. The outer sensor array has audio and video capabilities that include infrared, zoom and FLIRS technologies. This allows capture of fine detail for collecting evidentiary data for authorities and useful data for first responders providing emergency services.

During power outages the banking system is suspended to safeguard the banking customers and the safety door is closed and sealed until the event has concluded. The ATMS Terminal and Plaza are on an emergency power backup system that keeps the ATMS Network online with the BERS personnel until the power comes back on. If the power outage is community wide and the BERS Cloud Service is severed, an external emergency communications antenna is used to communicate with the BERS cloud service. This is only engaged when an emergency has been reported to the ATMS Terminal by a person in distress. During such periods where there is a disconnection in service, the live data will stream to an event folder located on the nexus of the ATM hard drive. The ATMS Terminal exterior sensor array and ATMS Plaza audio/video technologies will record all data and stream it to the local nexus event folder for upload when network connectivity is reestablished. This provides continuity with the ATMS Network. All data during blackouts are streamed into a power outage event folder with the day's date and outage time. If the BERS cloud is accessible the BERS personnel monitor the blackout event for the duration with full access to the cameras in the plaza. If someone approaches the ATMS Terminal during a power outage asking for help, The BERS personnel will assist the person and notify services requested and provide comfort to the person while waiting for help. This increases confidence within the community and deprives criminal activities within the area during such an event.

The ATMS Plaza has security columns surrounding the perimeter of the ATM area. These columns have lights and protective enclosures for the digital equipment to protect against rain and wind. These columns utilize High Definition audio and video technologies housed within just like the ATMS Terminal and can be positioned in any angle to provide investigators more detailed data for evidentiary collection. Infrared and FLIRS technologies are used to seek waiting accomplice cars and zoom in dark areas to reveal details such as VIN numbers, license plate numbers, make model and color of automobiles, facial characteristics, weapons discovered, clothing worn and details inside the vehicle that may help with the investigation. The cameras can track a suspect's vehicle down the street and offer the police a direction of flight. Facial recognition software at the police station and in patrol vehicles can help identify the perpetrator and known accomplices to make apprehension more expedient and knowledgeable.

The ATMS Terminal and surrounding Plaza form a high encryption Wi-Fi Network hotspot that directly communicates with the ATMS BERS cloud services. This strong encrypted network is powered by community utility power and a redundant power backup system that is located on the property that provides power to the ATMS Network during power failures and emergency situations such as blizzards, floods, hurricanes, and severe storms. The network is designed to monitor the plaza and record all events for later upload to the cloud if the local network service has been interrupted. This offline data collection provides valuable information to authorities if a murder has taken place; a robbery, rape, collapse of a building; and other first responder incidents occur. Emergency communication arrays to the plaza may be incorporated into the emergency power failure circuit to provide continuous data streaming to the cloud to enable the BERS personnel the ability to notify various first responder services in the area if an incident occurs that needs immediate action. An incident folder will be created and the hospital, emergency rescue personnel, fire department, FEMA, and police will have a one-time access code provided over the telephone to the emergency service to access the incident folder. This system is designed to save lives and ready personnel upon arriving at the scene of an emergency.

What is claimed is:

1. A method for safeguarding banking customers and banking institutions from ATM abuse and fraud through the use of the Automatic Teller Machine Security (ATMS) network, which incorporates the Banking Emergency Response Service (BERS), a cloud service, with a private ATM booth design and monitored ATM plaza sending live data to cloud folders with Discreet Action and Police Action PIN initiation by the customer in distress.

2. The method of claim 1 incorporates a method for banking institutions to allow a customer to add ATMS Personal Information Numbers to their Europay, MasterCard and Visa (EMV) cards to join the customer to the ATMS network. The ATMS will be offered by the banking institutions as a customer security support service to safeguard the customer and family from criminal activity based around the ATM technology.

3. The method of claim 2, wherein the customer is joined to the ATMS network, has the banking customer create a Bank Emergency Response Service Police Action (BERSPA) PIN and a Bank Emergency Response Service Discreet Action (BERSDA) PIN. These new numbers are added to the banking customer's EMV cards.

4. The method of redesign of the Automatic Teller Machine to incorporate said Technology into the new ATMS enclosure designs with enhanced technologies to improve the banking customer's experience at the ATM and increase the frequency of use through ATMS's security practices and customer security support service using the ATMS Terminal, BERS and Plaza security components.

5. The method of claim 4 and claim 2 implements new security procedures involving the customer interface enhancements to the ATM technology that abides by the PCI Counsel's primary concern of PIN security at the ATM. This compliance to the PCI Counsel's recommendations includes a biometric input at the ATMS Terminal service screen, which binds the customer to the ATM transaction and excludes those that have the EMV card and PIN, but no biometric proof of authorization to the banking customer's accounts.

6. The method of claim 4 in compliance to the Europay, MasterCard and Visa standard are necessary as the ATMS does allow the distressed banking customer access their accounts during an emergency though such access is delayed by ATMS software to keep the suspect on site for authoritative action.

7. The method of claim 5 with FICO Card Alert Services in conjunction with ATMS biometric authentication with new customer security support PINs added to EMV cards will reduce the methods of fraud at the local ATM.

8. A method for communicating through a secure portal to the BERS Cloud Service via TCP/IP services from the ATMS Terminal will require high encryption to secure servers using software based on UNIX programming. This will remove Windows-based vulnerabilities and secure communications in a compartmentalized operating system with built-in file security for cloud services security and stability.

9. The method of interface of the ATMS over the ATM software allows access to the customer accounts through continuity of the user interface whereby once a BERSPA or BERSDA PLN input has occurred, the ATMS initiates an incident folder in the BERS Cloud and all live audio/video data from the ATMS Terminal and Plaza are streamed into this folder and ATMS software is initiated to slow the ATM transaction considerably to keep the customer and suspect on site while authorities arrive to secure the incident.

10. The method of claim 9, whereas the ATMS Terminal Incident Response System notifies the BERS Cloud of the incident and an agent is immediately placed in charge of the ATMS Terminal and acts as a witness to the incident and a data extractor accessing all audio/video data in the ATMS Terminal and Plaza for streaming to an incident cloud folder for authoritative use.

11. The method of claim 10, whereas the BERS personnel are actively engaged in the incident at hand using the Terminal Identification Number and contacts the local authorities for assistance. The ATMS Terminal will slow the BERSPA and BERSDA event service screens using software stored in the nexus of the ATM hard drive interfacing with the BERS Cloud Service software to keep the event in play for as long as possible while BERS personnel wait for the authorities to arrive at location.

12. The method of claim 11, whereas the BERS personnel has notified the authorities for assistance depends on the ATMS PIN initiation that has been enabled, whereby the BERS Police Action will request a Police Officer to assist. This scenario could result in the security door closing to protect the customer where possible.

13. The method of claim 12, whereas the BERS personnel has notified the authorities for assistance depends on the ATMS PIN initiation that has been enabled, whereby the BERS Discreet Action will request assistance at the customer's residence and ATMS Terminal location, which will bring an unmarked police vehicle and responders to both locations.

14. A method for claim 1, whereas the ATM is physically upgraded to provide private booth, the ATMS Terminal, accommodations for handicap and various-sized banking customers. This upgrade includes a large touch screen that can be tapped by the banking customer to level the service screen to a convenient position to the customer.

15. A method for claim 14, whereas the upgraded ATMS Terminal design incorporates an external enclosed audio/video sensor array that monitors all activity for storage in the cloud daily live feed folder. The sensor array includes zoom optics, high definition audio/video devices; and infrared/FLIRS technologies to view dark areas that may hide weapons on suspects.

16. A method for claim 14, whereas the internal ATMS Terminal customer environment within the booth includes an enclosed internal audio/video sensor array working in conjunction with the adaptable flooring sensor that the customer steps on when inside the ATMS Terminal. This sensor allows the ATMS Terminal to adapt to the customer's dimensions and preposition the service screen for the customer. In BERSPA events the adaptable floor sensor mimics the customer's feet and prompts the customer to the correct position of feet prior to the security door closing. The adaptable floor sensor and internal sensor array scan and identify the number of occupants within the ATMS Terminal and the adaptable floor sensor can accommodate various sized footprints prior to shutting the door. If a suspect is in the booth with the banking customer, the BERS personnel can seal the door to hold the suspect or leave the door open depending on the situation. The BERS Personnel have full control of the ATMS Terminal.

17. The method of claim 16, whereas the ATMS Terminal has upgraded the design of the ATM whereby the AIMS Terminal utilizes a booth and security door with sensor arrays. The exterior of the ATMS Terminal can be bulletproof with added layers of material. Can have video film added to the exterior to allow for streaming of video advertisements to attract banking customers and inform new customers of benefits to banking. A solar film can also be added to charge batteries for use during emergencies. The ATMS logo can be affixed on the outside of the enclosure and security door of the ATMS Terminal.

18. The method of claim 17, whereas the exterior of the ATMS can have a solar film added overlaying other materials to act as a backup power source during power outages will provide the ATMS Terminal and Plaza Network power during power outages with batteries stored in the ATMS Terminal and the audio/video perimeter light columns surrounding the ATMS Plaza. Other backup devices can be located within the plaza for prolonged power outages and service interruptions to power and communications.

19. The method of claim 18, whereas the ATMS uses a backup power source to provide power to the ATMS Terminal and ATMS Plaza during power outages may also include a Wi-Fi Hotspot antenna with self-sustaining backup communications array to communicate outside of the localized area in case the local TCP/IP services are interrupted. This will provide access to the secure ATMS network and BERS cloud service during the event allowing the ability to stream live data to the cloud event folder and respond to emergencies from people requesting assistance during the event.

20. The method of claim 19, whereas the ATMS streams data over a Wi-Fi Hotspot communications array during power outages may also include a localized folder created in the nexus of the ATM hard drive or external hard drive within the ATMS Terminal housing to collect live data for upload streaming to the BERS Cloud when the local communication node is operable; an ATMS protocol when the ATMS communications array is inoperable.

21. The method of claim 19, whereas a blackout has occurred and the ATMS Terminal security door has been closed for the duration of the event. People approaching the ATMS Terminal can communicate with BERS personnel, if the communication node or ATMS communications array are operable, and request assistance. This service provides community support during blackout situations where violence can occur in increased frequency.

22. The method of claim 21, whereas the ATMS Terminal door has been secured during the duration of the blackout event. The banking functions of the ATMS Terminal have been suspended to protect the banking customer from violence during a power outage event.

23. The method of claim 22, whereas the banking functions have been suspended for the duration of the blackout event. The ATMS Plaza continues collecting live audio/video data and streams this data to a cloud event folder or the nexus location within the ATMS Terminal.

24. The method of claim 22, whereas the ATMS Terminal security door has been closed for the duration of a power outage. This procedure is repeated during severe storms to protect the customer and secure the ATMS Terminal from debris and destruction. During such events the ATMS Terminal external sensor array and plaza security network stream all live data to a cloud event folder or the nexus folder location within the ATMS Terminal. If someone requests help the ATMS Terminal will notify the BERS personnel to assist. If the network is down the emergency communication array, a battery operated satellite phone within the ATMS Terminal housing will connect to the cloud service to request assistance.

25. The method of claim 18, whereas the ATM has been upgraded to a more convenient and secure design. The convenience booth incorporates a check input slot, a cash withdrawal slot and a cash deposit slot located at the sides of the ATMS Terminal at a height that can be easily reached by handicap customers in wheelchairs and various sized banking customers. This increases accessibility to the ATMS Terminal for all banking customers.

26. The method for claim 25, whereas the convenience booth within the ATMS Terminal accommodates many sizes of customers. The booth design also has air conditioning that provides heat during the winter and cool air during the summer. This utility uses the local utility services for power and uses a different circuit than the core ATMS Terminal technology.

27. The method for claim 23, whereas the ATMS Plaza streams live audio/video data to the BERS Cloud incorporates lighted columns with audio/video technologies mounted on them to provide live audio/video data that is streamed to daily, event and incident BERS cloud folders. These columns facilitate enclosures whereby microphones, high definition video cameras on rotator arms, FLIR cameras to locate heat surrounding the facility and infrared cameras to record detailed night data. The BERS personnel can turn the column lights off to get better video if needed. These communication columns are interlinked to the ATMS Terminal with a high encryption key shared only with the ATMS Terminal and BERS Cloud Services. A request button can be added to the columns and terminal to provide assistance when needed.

28. The method for claim 27, whereas the ATMS network incorporates the use of perimeter surveillance lighted columns to facilitate audio/video streaming to secure cloud or local ATMS folders can also include plaza ground sensors to track patrons and assist with security.

29. The method of claim 25, whereas the ATM has been upgraded to a more convenient and secure design. Maintenance of the ATMS Terminal and Columns Surveillance enclosures are conducted through the ATMS BERS Cloud Service whereby the only access to the internal technology is governed by the BERS Personnel. During maintenance schedules the technician is scrutinized by the BERS Personnel who unlock the housings to the various compartments of the ATMS Terminal and Plaza Enclosures. Secure housings have no external access points.

30. The method of claim 28, whereas the perimeter surveillance lighted columns facilitate audio/video streaming to BERS Cloud Services. Streamed data is stored in Daily, Event, Incident, and Maintenance folders that are stored for three years on the ATMS Library Server. The Incident folders are available for online authoritative review for three years and must be checked out afterward from the Offline ATMS Library. Daily folders are deleted from the system after three years. Event folders and Maintenance folders are kept in internal ATMS Archive for training purposes.

31. The method of claim 9, whereas the ATMS BERS personnel have control of the ATM interface. The ATMS Terminal allows for two repeated EMV PIN inputs prior to the BERS Incident Response System initiation creating an incident folder and suspending the EMV card in the mechanism. This ensures that unauthorized people do not access EMV accounts. If a person inserts the EMV card into the ATMS Terminal card slot and enters the standard PIN for the card, the ATMS Terminal gives the patron ten seconds to enter the biometric fingerprint in the lower right side of the service screen. This area is not advertised and only the customer will understand this protocol. The standard PIN entered by the patron clears after ten seconds. After the second input an incident folder is created and BERS personnel access the ATMS Terminal and observe what happens next. When the patron attempts to eject the card the BERS personnel intercede and challenge the patron for the correct credentials leading to the biometric scan. The security door can be used to secure a criminal or the customer can be reminded of the protocol and continue with the ATM transaction when a biometric signature has been received.
